(19) United States
(12) Patent Application Publication
(10) Pub. No.: US 2025/0260661 A1
(43) Pub. Date: Aug. 14, 2025

(54) Method And Non-Transitory Computer-Readable Medium For Providing Incoming Messages Sent From A Trusted Sender To A User

(71) Applicant: OPTMSG, LLC, Bloomfield Twp., MI (US)

(72) Inventors: Matthew J. Dobbie, Bloomfield Hills, MI (US); Ryan LaMirand, Bloomfield Twp., MI (US)

(73) Assignee: OPTMSG, LLC, Bloomfield Twp., MI (US)

(21) Appl. No.: 19/051,635

(22) Filed: Feb. 12, 2025

Related U.S. Application Data
(60) Provisional application No. 63/552,339, filed on Feb. 12, 2024.

(51) Int. Cl. H04L 51/212; H04L 9/40; H04L 51/42

(52) U.S. Cl. CPC H04L 51/212; H04L 51/42; H04L 63/126

(57) ABSTRACT

A non-transitory computer-readable medium is provided. The non-transitory computer-readable medium includes instructions, which when executed by one or more processors, are configured to store a list of trusted identifiers, add an identifier to the list of trusted identifiers, receive an incoming message, determine whether the identifier of the incoming message is included in the list of trusted identifiers, and provide the incoming message to a user in response to determining that the identifier of the incoming message is included in the list of trusted identifiers.

### TECHNICAL FIELD

The present disclosure relates generally to computer security, and more specifically to removing untrusted email messages from an email inbox.

### BACKGROUND

Currently, anyone with a valid email address can send a message via Simple Mail Transport Protocol (SMTP) for delivery to a user's inbox. The user has no say over what emails are delivered to them. Although some emails may be randomly identified as “spam” by their email provider's SPAM filters and sent to a corresponding folder titled “spam”, this is not a full proof system, so the user's inbox is typically filled with unwanted spam emails from advertisers and/or cyber criminals. There remains a need in the art to allow the user to determine which emails are delivered to them and to better protect the user from unwanted spam emails from advertisers and/or cyber criminals.

### SUMMARY

According to a first aspect, a non-transitory computer-readable medium comprising instructions, which when executed by one or more processors, are configured to: store a list of trusted identifiers, wherein each trusted identifier corresponds to an trusted sender; add an identifier to the list of trusted identifiers in response to receiving an input; receive an incoming message, wherein the incoming message includes an identifier corresponding to a sender of the incoming message; determine whether the identifier of the incoming message is included in the list of trusted identifiers; and provide the incoming message to a user in response to determining that the identifier of the incoming message is included in the list of trusted identifiers.

According to a second aspect, a method of providing messages to a user from a trusted sender, the method comprising steps of: storing a list of trusted identifiers, wherein each trusted identifier corresponds to a trusted sender; adding an identifier to the list of trusted identifiers in response to receiving an input; receiving an incoming message, wherein the incoming message includes an identifier corresponding to a sender of the incoming message; determining whether the identifier of the incoming message is included in the list of trusted identifiers; and providing the incoming message to a user in response to determining that the identifier of the incoming message is included in the list of trusted identifiers.

### BRIEF DESCRIPTION OF THE DRAWINGS

Advantages of the present invention will be readily appreciated as the same becomes better understood by reference to the following detailed description when considered in connection with the accompanying drawings.

FIG. 1 illustrates a method of providing incoming messages sent from a trusted sender to a user.

FIG. 2 is a flowchart illustrating the method of FIG. 1.

FIG. 3 illustrates additional steps of the method of FIG. 1 for suggesting a trusted sender to the user.

FIG. 4 is a flowchart illustrating the additional steps of method of FIG. 3.

FIG. 5 is a schematic view of adding a suggested trusted sender to a list of suggested trusted senders.

FIG. 6 is an example table for adding a suggested trusted sender to a list of suggested trusted senders.

FIG. 7 is a perspective view of a user interface of a computing device, the user interface providing a message from a suggested trusted sender to a user of the computing device.

### DETAILED DESCRIPTION

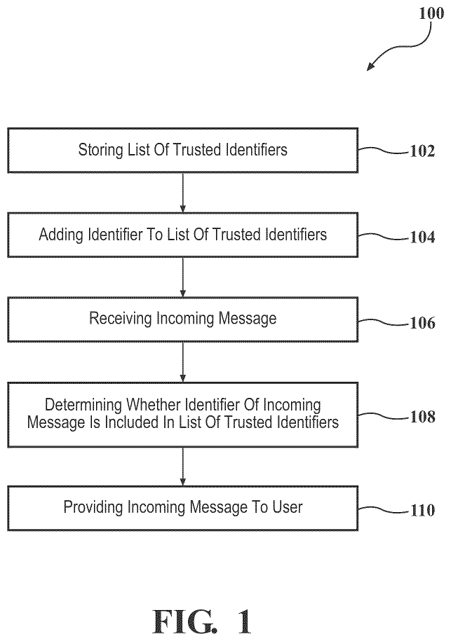

Referring to FIG. 1, a method 100 of providing incoming messages sent from a trusted sender to a user is shown. Generally, a trusted sender may be defined as a sender of an incoming message that has been indicated by the user as “trusted”. In this way, by indicating which senders are “trusted”, the user may authorize which incoming messages should be provided and which incoming messages should be ignored. The method 100 may be executed by a local or mobile computing device and the user of the local or mobile computing device may be referred to herein as the “user”.

As shown in FIG. 1, the method 100 includes a step 102 of storing a list of trusted identifiers, wherein each trusted identifier corresponds to a trusted sender; a step 104 of adding an identifier to the list of trusted identifiers in response to receiving an input; a step 106 of receiving an incoming message, wherein the incoming message includes an identifier corresponding to a sender of the incoming message; a step 108 of determining whether the identifier of the incoming message is included in the list of trusted identifiers; and a step 110 of providing the incoming message to the user in response to determining that the identifier of the incoming message is included in the list of trusted identifiers.

The method 100 according to the present disclosure may be implemented in hardware or firmware, or may be implemented as software or computer code that can be stored in a recording medium (for example, a CD ROM, a RAM, a floppy disk, a hard disk or a magneto-optical disc), or may be implemented as computer code that is downloaded from a network, is stored in a remote recording medium or a non-transitory machine-readable medium originally, and will be stored in a local recording medium. It may be understood that a local or mobile computing device, a processor, a microprocessor controller, or programmable hardware may execute the method 100. In one implementation, the method 100 may be implemented as computer code on a computing device and may be executed via an application downloaded to the computing device. The application may be automatically updated or in response to a confirmation inputted by the user once the application has been downloaded to the computing device. Additionally, the local or mobile computing device, the processor, the microprocessor controller, or the programmable hardware may include or be in communication with a local or remote storage component (e.g., a local or remote RAM, a ROM, or a flash memory) that can store or receive software, computer code, and/or information for use during execution of the method 100. When the software or computer code is accessed and executed by the computing device, the processor, or the hardware, the method 100 described herein is implemented. In addition, when a general-purpose computing device accesses code that is used for implementing processing shown herein, execution of the code converts the general-purpose computing device to a special-purpose computing device configured to execute the method 100 shown herein.

The method 100 may be executed to provide an incoming message of any suitable type to the user. For example, the incoming message provided to the user may be an email message received from a Simple Mail Transport Protocol (SMTP) email server, a Short Message Service (SMS) message, a Multimedia Messaging Service (MMS) message, a Rich Communication Service (RCS) message, a device-exclusive message (e.g. iMessage), a third-party application message corresponding to an application software, and the like. Correspondingly, the trusted identifier may be an identifier corresponding to the type of the incoming message. For example, the trusted identifier may be an email address, a phone number, a username for a third-party application, and the like.

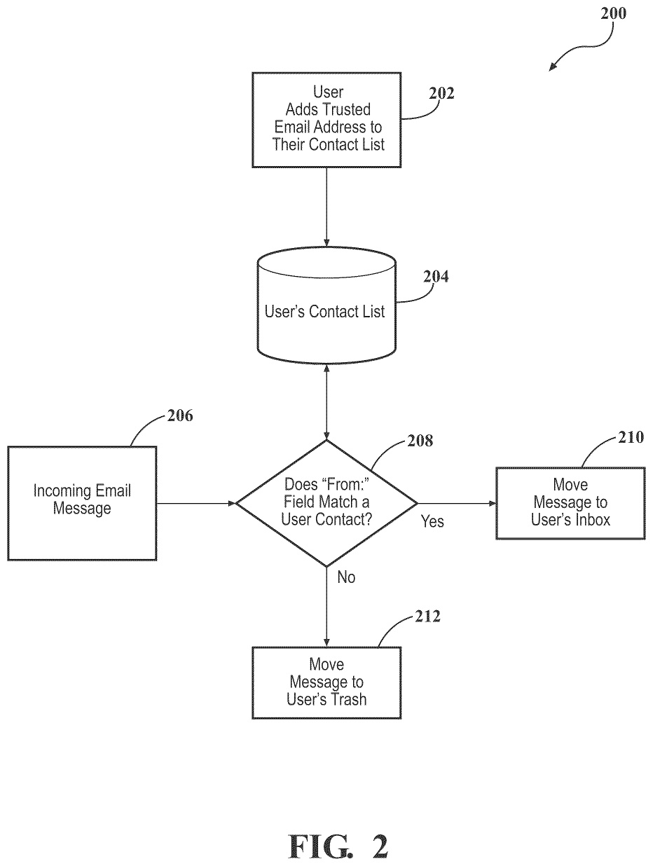

FIG. 2 includes a flowchart 200 executable by a processor, the flowchart 200 further illustrating the steps 102-110 of the method 100. In the instance of FIG. 2, the incoming message is represented as an email message received from a Simple Mail Transport Protocol (SMTP) email server. However, it is contemplated that, in other instances of the method 100, the incoming message may be an incoming message of any of the above-described suitable messaging types.

The step 102 of storing a list of trusted identifiers is represented using block 204 of FIG. 2. As shown, the stored list of trusted identifiers is represented as a contact list 204, which may be stored on a local memory of a computing device or a memory of a remote computing device (e.g., a cloud server). In the instance of FIG. 2, the contact list 204 includes a list of trusted email addresses.

The step 104 of adding an identifier to the list of trusted identifiers in response to receiving an input is represented using block 202 of FIG. 2. The input may be a user input, which includes an identifier. During step 104, the identifier of the user input may be added to the list of trusted identifiers. In the instance of FIG. 2, the user input is a contact added by the user and the identifier is an email address of the contact. As shown, the user adds the contact and, therefore, the email address to their contact list 204 in block 202. By adding the email address to the contact list 204, the user indicates that the added email address is a “trusted” email address. In an example implementation, the user may interact with a user interface of a computing device to add a new contact including an associated email address to the contact list 204. It should be noted that the user may also remove an identifier from the list of trusted identifiers. In one such implementation, the user may interact with a user interface of a computing device to remove an existing contact including an associated email address from the contact list 204.

The list of trusted identifiers may correspond to a list of contacts maintained by the user. For example, in some instances, the method 100 may be executed via an application on a computing device and the contact list 204 may correspond to a list of contacts maintained by a different application of the computing device. In one such implementation, an operating system of a computing device may maintain a list of contacts and the contact list 204 may include all contacts from the maintained list of contacts. As follows, addition/removal of a contact to/from the maintained list of contacts may be reflected by the contact list 204.

An identifier may be added to the list of trusted identifiers using a variety of methods. For example, in one instance, the user may import a list of contacts to the contact list 204 of FIG. 2. In one such implementation, a user interface of a computing device executing the method 100 may provide a “Contact Import” function, selectable by the user, that will copy all the user's current contacts stored on their computing device or other third-party applications into the contact list 204. In another instance, a user interface of a computing device executing the method 100 may provide an “Opt-In” function, to be authorized by the user, for any identifier (e.g., email address) to add a sender's identifier to an existing contact or create a new contact to confirm the sender's identifier as a trusted identifier. In some instances, if the user sends a message to an identifier (e.g., email address) that is not currently listed in the contact list 204, the user will be prompted to add the identifier to the contact list 204. The user may then authorize or reject the addition of the identifier to the contact list 204.

In some instances, only the user may add/remove an identifier to/from the list of trusted identifiers. Advantageously, instances including such a restriction provides the user with full customization of provided incoming messages. In other words, such a restriction allows only the user to determine which incoming messages should be provided and which incoming messages should be ignored. In one such implementation, the user may add/remove a contact to/from the maintained list of contacts, the addition/removal being reflected by the contact list 204.

The step 106 of receiving an incoming message is represented using block 206 of FIG. 2. In the instance of FIG. 2, the incoming message is further defined as an email message 206 received from a sender via a Simple Mail Transport Protocol (SMTP) email server.

The step 108 of determining whether the identifier of the incoming message is included in the list of trusted identifiers is represented using block 208 of FIG. 2. In the instance of FIG. 2, the identifier of the incoming message is an email address of the sender of the email message 206. In block 208, the email address of the sender is compared with the trusted email addresses of the contact list 204 to determine whether the email address of the sender is a trusted email address. If the email address of the sender matches a trusted email address of the contact list 204, the incoming email message 206 is provided to the user in block 210.

The step 110 of providing the incoming message to the user in response to determining that the identifier of the incoming message is included in the list of trusted identifiers is represented using block 210 of FIG. 2. The method 100 may include a step of providing the incoming message to the user by adding the incoming message to an electronic inbox. In the instance of FIG. 2, the incoming message is the email message 206 and may be provided to the user via an email inbox viewable by the user. In one implementation, the user may view the email inbox as a graphical user interface provided by a computing device. In instances where the incoming message is not an email message, the incoming message may be provided to the user via any suitable electronic inbox viewable by the user. For example, in an instance where the incoming message is an SMS message, the SMS message may be provided to the user via an SMS inbox. As another example, in an instance where the incoming message is a third-party application message, the third-party application message may be provided via the corresponding third-party application.

Additionally, the method 100 may include a step of adding the incoming message to an electronic trash folder in response to determining that the identifier of the incoming message is not included in the list of trusted identifiers. In the instance of FIG. 2, if the email address of the sender does not match a trusted email address of the contact list 204, the email message 206 may be added to an electronic email trash folder in block 212. In instances where the incoming message is not an email message, the incoming message may be added to any suitable electronic trash folder. For example, in an instance where the incoming message is an SMS message, the SMS message may be added to an SMS electronic trash folder. As another example, in an instance where the incoming message is a third-party application message, the third-party application message may be added to an electronic trash folder of the corresponding third-party application. In some instances, the electronic trash folder may be viewable by the user.

In some instances, the method 100 may include additional steps for suggesting a trusted sender to the user. Generally, in such instances, a suggested trusted sender may be inputted by a third-party and the user may review the suggested trusted sender and authorize the providing of incoming messages from the suggested trusted sender. For example, during execution of steps 102-110 of the method 100, an incoming message may be determined to be from an untrusted sender based on the identifier of the incoming message not being included in the list of trusted identifiers. During the additional steps of the method 100 for suggesting a trusted sender to the user, the incoming message from the untrusted sender may be determined to be from a suggested trusted sender and provided to the user based on the identifier of the incoming message being included in a list of third-party trusted identifiers.

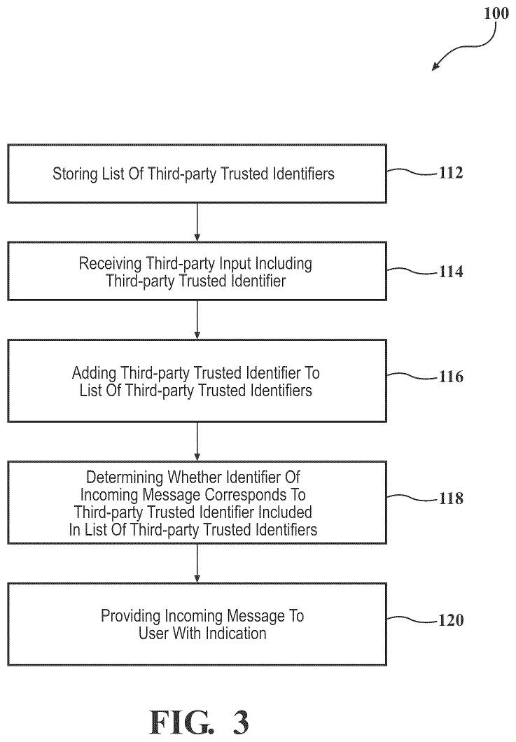

FIG. 3 illustrates the additional steps of method 100 for suggesting a trusted sender to the user. As shown, the method 100 may include an additional step 112 of storing a list of third-party trusted identifiers; an additional step 114 of receiving a third-party input, where the third-party input includes a third-party trusted identifier; an additional step 116 of adding the third-party trusted identifier to the list of third-party trusted identifiers in response to receiving a third-party input; an additional step 118 of determining whether the identifier of an incoming message corresponds to the third-party trusted identifier in response to determining that the identifier of the incoming message is not included in the list of trusted identifiers; and an additional step 120 of providing the incoming message to the user with an indication in response to determining that the identifier of the incoming message corresponds to the third-party trusted identifier.

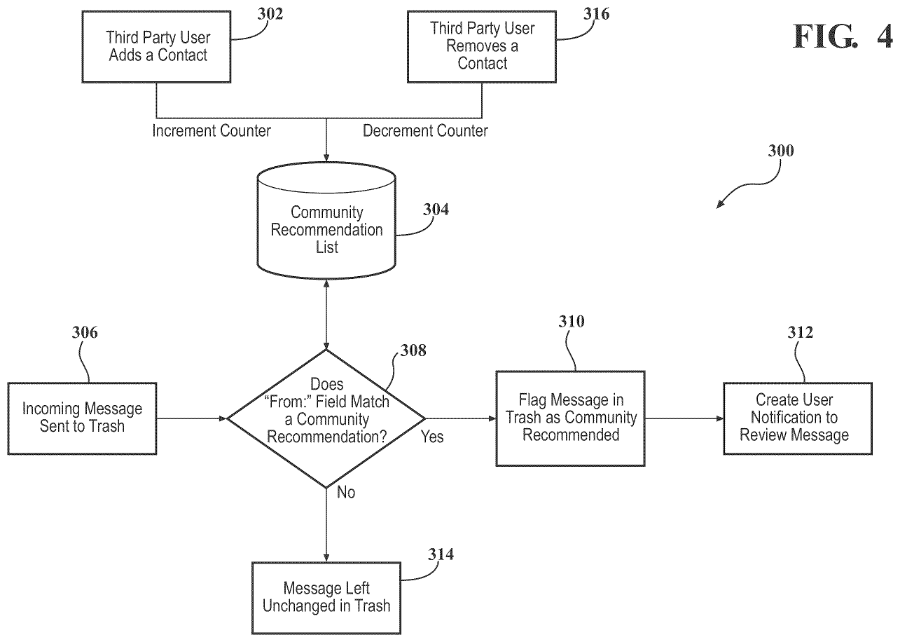

FIG. 4 includes a flowchart 300 executable by a processor, the flowchart 300 further illustrating the additional steps 112-120 of the method 100. Like the instance of FIG. 2, the incoming message in FIG. 3 is represented as an email message received from a Simple Mail Transport Protocol (SMTP) email server. However, it is contemplated that, in other instances of the method 100, the incoming message may be an incoming message of any of the above-described suitable messaging types.

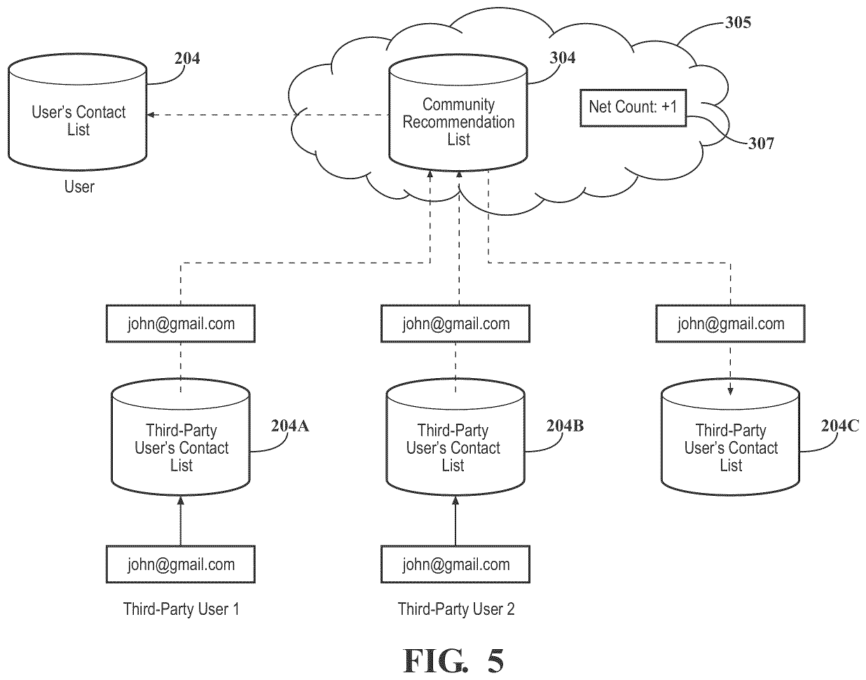

The step 112 of storing a list of third-party trusted identifiers is represented using block 304 of FIG. 4. As shown, the stored list of third-party trusted identifiers is represented as a community recommendation list 304. In the instance of FIG. 4, the community recommendation list 304 includes a list of third-party trusted email addresses. Additionally, the stored list of third-party trusted identifiers may be stored on a local memory of a computing device or a memory of a remote computing device (e.g., a cloud server). For example, in the instance of FIG. 5, the community recommendation list 304 is stored on a cloud server 305.

The step 114 of receiving a third-party input including a third-party trusted identifier and the step 116 of adding the third-party trusted identifier to the list of third-party trusted identifiers are represented using block 302 of FIG. 4. In the instance of FIG. 4, the third-party input is further defined as a user input received from a third-party user. As shown, the third-party user input is a contact added by the third-party user and the identifier is an email address of the contact.

FIG. 5 further illustrates an example implementation of steps 114 and 116 of the method 100 and the block 302 of FIG. 4. As previously stated, the method 100 described herein may be executed by a computing device corresponding to a user. Referring to FIG. 5, such a user is indicated as “User”. Additionally, a plurality of computing devices may be configured to execute the method 100, where each computing device corresponds to a different user. In such instances, during execution of the method 100 by a computing device, a user other than the user corresponding to the computing device may be defined as a “third-party user”. Referring to FIG. 5, the third-party users are indicated as “Third Party User 1”, “Third Party User 2”, and “Third Party User 3”. As shown, in FIG. 5, “Third Party User 1” and “Third Party User 2” both add “john@email.com” to their respective contact lists 204A, 204B in accordance with the previously described methods of adding/removing a contact by a user. In one such instance, the “Third Party User 1” and “Third Party User 2” may interact with a user interface of a computing device to add a new contact including the associated email address, “john@email.com”, to their respective contact list 204A, 204B. As follows, “john@email.com” may be added to the community recommendation list 304 and may be indicated as a “third-party trusted” email address.

In some instances, an administrator may add a third-party identifier to the list of third-party identifiers. In instances where the method 100 is implemented as computer code on a computing device and may be executed via an application downloaded to the computing device, the application may be downloaded with a third-party identifier added to the list of third-party identifiers by the administrator. In other such instances, the administrator may add a third-party identifier to the list of third-party via an update to the application.

Block 306 of FIG. 4 represents an incoming message 306 from an untrusted sender that has been previously added to an electronic trash folder. As previously stated, during execution of steps 102-110 of the method 100, an incoming message may be determined to be from an untrusted sender based on the identifier of the incoming message not being included in the list of trusted identifiers. In some instances, the incoming message from the untrusted sender may then be added to an electronic trash folder. For instance, email message 206 may be moved to an electronic email trash folder in block 212 of FIG. 2.

During step 118, determination of whether the identifier of an incoming message corresponds to a third-party trusted identifier occurs in response to determining that the identifier of the incoming message is not included in the list of trusted identifiers. In the instance of FIG. 4, the incoming email message 306 was previously determined as including an identifier not included in the list of trusted identifiers (e.g., the contact list 204 of FIG. 2) and was added to an electronic email trash folder (see block 212 of FIG. 2). The method 100 then determines whether the identifier of the incoming email message 306 corresponds to a third-party trusted identifier in response to the incoming email message 306 being trashed.

Determination of whether the identifier of an incoming message corresponds to a third-party trusted identifier is represented using block 308 of FIG. 4. In block 308, the email address of the sender of the trashed email message 306 is compared with the third-party trusted email addresses of the community recommendation list 304 to determine whether the email address of the sender is a third-party trusted email address. If the email address of the sender matches a third-party trusted email address of the community recommendation list 304, the trashed email message 306 is determined to be from a suggested trusted sender and the trashed email message 306 is provided to the user. If the email address of the sender does not match a third-party trusted email address of the community recommendation list 304, the trashed email message 306 is not provided to the user and is left unchanged in the electronic trash folder, as represented by block 314.

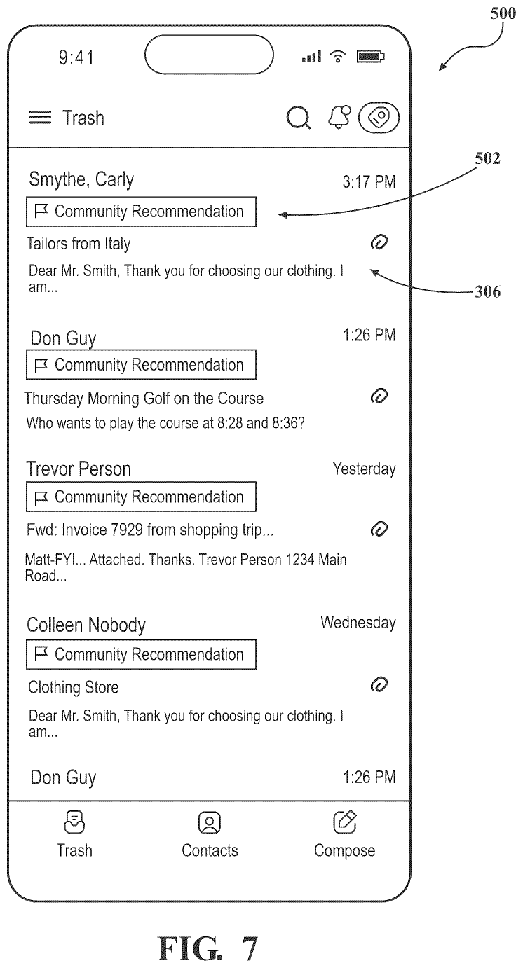

The step 120 of providing the incoming message from a suggested trusted sender to the user is represented using blocks 310 and 312 of FIG. 4. In the instance of FIG. 4, the trashed email message 306 is provided to the user with an indication by being flagged in the electronic email trash folder. An example implementation of block 310 is shown in FIG. 7. As shown, the electronic email trash folder 500 is viewable by a user via a user interface of a computing device. Additionally, the trashed email message 306 is provided with a “Community Recommendation” flag 502. Referring back to FIG. 4, a user notification may also be created to inform the user of that the trashed email message 306 has been flagged. In one implementation, the user interface of the computing device (e.g., a home/lock screen displayed on the computing device) may provide an audio, visual, and/or tactile notification informing the user that the trashed email message 306 has been flagged.

In some instances, the user may review the incoming message from a suggested trusted sender and determine whether to add the identifier corresponding to the suggested trusted sender to the list of trusted identifiers. For instance, the user may add the email address of the sender of the trashed email message 306 to the contact list 204. In one such implementation, the user interface of the computing device may present a dialogue box requesting addition of the email address of the sender of the trashed email message 306 to the contact list 204. As follows, the email address of the sender would be added to the contact list during step 104, the suggested trusted sender would become a trusted sender, and incoming messages from the suggested trusted sender would be provided to the user during step 110 of the method 100. The user may add the identifier of the incoming message from a suggested trusted sender to the list of trusted identifiers in accordance with the above-described methods.

In some instances, the method 100 may include an additional step of adding a third-party trusted identifier to the list of third-party trusted identifiers based on the number of third-party inputs and a predetermined threshold number. In such an instance, the method 100 would include a step of determining a number of third-party inputs received, wherein each third-party input includes the third-party trusted identifier, and comparing the number of third-party inputs to the predetermined threshold number. For example, a counter may be incremented in response to a third-party user adding a third-party trusted identifier during step 112. In the instance of FIG. 4, the counter may be incremented in response to the third-party user adding a contact. Additionally, the counter may be decremented in response to a third-party user removing a third-party trusted identifier during step 112. In the instance of FIG. 4, the counter may be incremented in response to the third-party user removing a contact.

FIG. 5 further illustrates the number of third-party inputs. In the instance of FIG. 5, “Third-Party User 1” and “Third Party User 2” have added “john@email.com” to their respective contact lists 204A, 204B, incrementing the net counter 307. Additionally, “Third-Party User 3” has removed “john@email.com” from their contact list 204C, decrementing the net counter 307. As such, the net number of third-party inputs received including “john@email.com” after the additions by “Third-Party User 1” and “Third Party User 2” and the removal by “Third-Party User 3” would be 1, as indicated by the net counter 307.

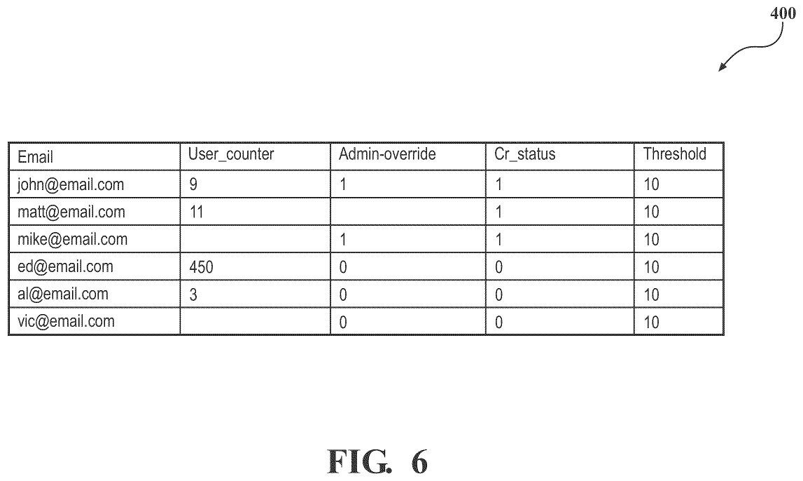

The example table 400 of FIG. 6 illustrates a total number of third-party inputs. For example, referring to the “User_counter” column of the table 400, the number of third-party trusted identifiers received for “john@email.com” is 9. In one instance, the number of third-party trusted identifiers received for “john@email.com” may be updated from 8 to 9 after to the additions and removal of “john@email.com” by “Third-Party User 1”, “Third Party User 2”, and “Third-Party User 3” in FIG. 5.

The example table 400 of FIG. 6 also illustrates comparing the number of third-party inputs and a predetermined threshold number. Referring to the “Threshold” column of the table 400, the predetermined threshold number for the instance of FIG. 6 is 10. As such, in instances where the number of third-party inputs including a third-party trusted identifier is greater than 10, the third-party trusted identifier would be added to the list of third-party trusted identifiers (e.g., the community recommendation list 304 of FIGS. 4 and 5). For example, referring to the “User_counter” column of the table 400, the number of third-party trusted identifiers received for “ed@email.com” is 450, therefore, “ed@email.com” would be added to the community recommendation list 304. The addition of “ed@email.com” is reflected in the “Cr_status” column of the table 400, which is labelled “1” as “ed@email.com” has been added to the community recommendation list 304. In instances where the number of third-party inputs including a third-party trusted identifier is not greater than 10, the third-party trusted identifier would not be added to the list of third-party trusted identifiers. For example, referring to the “User_counter” column of the table 400, the number of third-party trusted identifiers received for “al@email.com” is 3, therefore, “al@email.com” would not be added to the community recommendation list 304. The “Cr_status” column for “al@email.com” is labelled “0” as “al@email.com” has not been added to the community recommendation list 304.

In some instances, the predetermined threshold number may vary. For example, the predetermined threshold number may be a different threshold number, such as 3, 5, 25, 50, 100, etc. As another example, the predetermined threshold number may be modified by the user. In one such implementation, the user may interact with a user interface of a computing device to increase or decrease the predetermined threshold number from a default number.

In some instances, an administrator may provide an override for a third-party trusted identifier to add a third-party trusted identifier to the list of third-party trusted identifiers. In such instances, the third-party trusted identifier for which the administrator has provided an override would be added to the list of third-party trusted identifiers even if the number of third-party inputs including the third-party trusted identifier is not greater than the predetermined threshold number. For example, referring to the “Admin-override” column of the table 400, “john@email.com” and “mike@email.com” have received an override. As a result, “john@email.com” and “mike@email.com” would be added to the community recommendation list 204 despite “9” and “0” third-party inputs including “john@email.com” and “mike@email.com”, respectively. In instances where the method 100 is implemented as computer code on a computing device and may be executed via an application downloaded to the computing device, the application may be downloaded with such an override. In other such instances, the administrator may provide such an override via an update to the application.

In some instances, an administrator may provide an override for a third-party trusted identifier to remove a third-party trusted identifier from the list of third-party trusted identifiers. In such instances, the third-party trusted identifier for which the administrator has provided an override would be removed from the list of third-party trusted identifiers even if the number of third-party inputs including the third-party trusted identifier is greater than the predetermined threshold number. Advantageously, such an override provides a means of removing third-party trusted identifiers that may have been falsely added to the list of third-party trusted identifiers. In instances where the method 100 is implemented as computer code on a computing device and may be executed via an application downloaded to the computing device, the application may be downloaded with such an override. In other such instances, the administrator may provide such an override via an update to the application.

In some implementations, messages in the electronic trash folder may be deleted after a predetermined amount of time. For example, messages in the electronic trash folder may be deleted after 7 days, 30 days, 60 days, etc. Current email services require the user to manually delete an email they no longer want.

The embodiments discussed above provide several advantages to the user. For example, the method 100 ensures only messages from a trusted source, as defined by the user in the list of trusted identifiers, are displayed in the electronic inbox. Additionally, any message that is received that does not include an identifier in the list of trusted identifiers may be sent directly to the electronic trash folder. In combination, the method 100 provides a very clean electronic inbox that is devoid of unwanted emails. Furthermore, the method 100 provides additional security, warning users via the electronic trash folder that a message may be harmful since it was sent from an unknown source (the message includes an identifier not included in the list of trusted identifiers). Users may knowingly proceed with caution before opening a message if the message has not been indicated as being from a suggested trusted sender.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A non-transitory computer-readable medium comprising instructions, which when executed by one or more processors, are configured to:
store a list of trusted identifiers, wherein each trusted identifier corresponds to a trusted sender;
add an identifier to the list of trusted identifiers in response to receiving an input;
receive an incoming message, wherein the incoming message includes an identifier corresponding to a sender of the incoming message;
determine whether the identifier of the incoming message is included in the list of trusted identifiers; and
provide the incoming message to a user in response to determining that the identifier of the incoming message is included in the list of trusted identifiers.

2. The non-transitory computer-readable medium of claim 1, wherein the instructions, when executed by the one or more processors, are further configured to add the incoming message to an electronic inbox viewable by the user to provide the incoming message to the user.

3. The non-transitory computer-readable medium of claim 1, wherein the instructions, when executed by the one or more processors, are further configured to add the incoming message to an electronic trash folder in response to determining that the identifier of the incoming message is not included in the list of trusted identifiers.

4. The non-transitory computer-readable medium of claim 3, wherein the electronic trash folder is viewable by the user.

5. The non-transitory computer-readable medium of claim 1, wherein the instructions, when executed by the one or more processors, are further configured to:
store a list of third-party trusted identifiers;
add a third-party trusted identifier to the list of third-party trusted identifiers in response to receiving a third-party input;
determine whether the identifier of the incoming message corresponds to a third-party trusted identifier included in the list of third-party trusted identifiers in response to determining that the identifier of the incoming message is not included in the list of trusted identifiers; and
provide the incoming message to the user with an indication in response to determining that the identifier of the incoming message corresponds a third-party trusted identifier included in the list of third-party trusted identifiers.

6. The non-transitory computer-readable medium of claim 5, wherein the instructions, when executed by the one or more processors, are further configured to:
determine a number of third-party inputs received, wherein each third-party input includes the third-party trusted identifier; and
add a third-party trusted identifier to the list of third-party trusted identifiers based on the number of third-party inputs and a predetermined threshold number.

7. The non-transitory computer-readable medium of claim 1, wherein the input is further defined as a user input including an identifier, and further comprising a step of adding the identifier of the user input to the list of trusted identifiers.

8. The non-transitory computer-readable medium of claim 1, wherein the incoming message is further defined as an email message, and wherein the instructions, when executed by one or more processors, are configured to receive the incoming message from a Simple Mail Transport Protocol (SMTP) email server.

9. The non-transitory computer-readable medium of claim 8, wherein the identifier is further defined as an email address.

10. The non-transitory computer-readable medium of claim 8, wherein the instructions, when executed by one or more processors, are configured to provide the incoming message to the user via an email inbox viewable by the user.

11. A method of providing incoming messages sent from a trusted sender to a user, the method comprising steps of:
storing a list of trusted identifiers, wherein each trusted identifier corresponds to a trusted sender;
adding an identifier to the list of trusted identifiers in response to receiving an input;
receiving an incoming message, wherein the incoming message includes an identifier corresponding to a sender of the incoming message;
determining whether the identifier of the incoming message is included in the list of trusted identifiers; and
providing the incoming message to a user in response to determining that the identifier of the incoming message is included in the list of trusted identifiers.

12. The method of claim 11, wherein the step of providing the incoming message to the user further includes a step of adding the incoming message to an electronic inbox viewable by the user.

13. The method of claim 11, further comprising a step of adding the incoming message to an electronic trash folder viewable by the user in response to determining that the identifier of the incoming message is not included in the list of trusted identifiers.

14. The method of claim 13, wherein the electronic trash folder is viewable by the user.

15. The method of claim 11, further comprising steps of:
storing a list of third-party trusted identifiers;
adding a third-party trusted identifier to the list of third-party trusted identifiers in response to receiving a third-party input;
determining whether the identifier of the incoming message corresponds to a third-party trusted identifier included in the list of third-party trusted identifiers in response to determining that the identifier of the incoming message is not included in the list of trusted identifiers; and
providing the incoming message to the user with an indication in response to determining that the identifier of the incoming message corresponds a third-party trusted identifier included in the list of third-party trusted identifiers.

16. The method of claim 15, further comprising steps of:
determining a number of third-party inputs received, wherein each third-party input includes the third-party trusted identifier; and
adding a third-party trusted identifier to the list of third-party trusted identifiers based on the number of third-party inputs and a predetermined threshold number.

17. The method of claim 11, wherein the input is further defined as a user input including an identifier, and further comprising a step of adding the identifier of the user input to the list of trusted identifiers.

18. The method of claim 11, wherein the incoming message is further defined as an email message, and wherein the step of receiving the incoming message further comprises a step of receiving the incoming message from a Simple Mail Transport Protocol (SMTP) email server.

19. The method of claim 11, wherein the identifier is further defined as an email address.

20. The method of claim 19, wherein the step of providing the incoming message comprises providing the incoming message to the user via an email inbox viewable by the user.
